(19) United States
(12) Patent Application Publication
(10) Pub. No.: US 2020/0130056 A1
(43) Pub. Date: Apr. 30, 2020

(54) METHOD FOR A COMPONENT WITH A PREDETERMINED SURFACE STRUCTURE TO BE PRODUCED BY ADDITIVE MANUFACTURING

(71) Applicant: Siemens Aktiengesellschaft, Munich (DE)

(72) Inventor: Ole Geisen, Berlin (DE)

(73) Assignee: Siemens Aktiengesellschaft, Munich (DE)

(21) Appl. No.: 16/628,666

(22) PCT Filed: Jun. 26, 2018
(86) PCT No.: PCT/EP2018/067017

§ 371 Date: Jan. 4, 2020

(30) Foreign Application Priority Data
Jul. 14, 2017 (DE) 10 2017 212 110.6

(51) Int. Cl. B22F 3/105; B33Y 10/00

(52) U.S. Cl. CPC B22F 3/1055; B33Y 30/00; B33Y 10/00

(57) ABSTRACT

A method for providing a component that is to be produced layer by layer with a predetermined surface structure includes choosing an irradiation pattern for fusing a starting material in powder form for the component in such a way that, in a specific sequence of layers, a surface irradiating vector and/or a contour irradiating vector of a component layer to be fused are set in such a way that the predetermined surface structure is created during the build-up of the layers. A corresponding component and a corresponding computer program are specified.

### CROSS REFERENCE TO RELATED APPLICATIONS

This application is the US National Stage of International Application No. PCT/EP2018/067017 filed 26 Jun. 2018, and claims the benefit thereof. The International Application claims the benefit of German Application No. DE 10 2017 212 110.6 filed 14 Jul. 2017. All of the applications are incorporated by reference herein in their entirety.

### FIELD OF INVENTION

The present invention relates to a method for providing a component to be produced or that has been produced layerwise or additively with a predetermined surface structure on a side surface. An additive production method for the component is furthermore provided, the component having the predetermined surface structure. A corresponding computer program is furthermore proposed.

The component is advantageously intended for use in a turbomachine, advantageously in the hot-gas path of a gas turbine. The component advantageously consists of a nickel-based alloy or superalloy, in particular a nickel-based or cobalt-based superalloy. The alloy may be precipitation-hardened or dispersion-hardened.

### BACKGROUND OF INVENTION

Generative or additive production methods comprise, for example, as powder bed method methods selective laser melting (SLM) or laser sintering (SLS), or electron beam melting (EBM). Additive methods likewise include laser deposition welding (LMD).

A selective laser melting method is known, for example, from EP 2 601 006 B1.

Additive manufacturing methods have proven particularly advantageous for complex or complicatedly or filigree-designed components, for example labyrinth-like structures, cooling structures and/or lightweight structures. In particular, additive manufacture is advantageous because of a particularly short chain of process steps, since a step of production or manufacture of a component can be carried out directly on the basis of a corresponding CAD file.

Furthermore, additive manufacture is particularly advantageous for the development or production of prototypes which cannot be produced, or cannot be produced efficiently, by means of conventional subtractive or machining methods or casting technology.

For particular functions of the component, for example heat transfer or flow guiding, particular surface conditions, topologies or roughnesses are required or advantageous. Even though outer surfaces of the component are accessible for finishing, in particular inner-lying surfaces of the component, which for example define flow or cooling channels, can subsequently scarcely be modified or tailored in terms of roughness.

### SUMMARY OF INVENTION

It is therefore an object of the present invention to provide means with which a component can already be provided with particular surface properties, in particular a predetermined surface structure, during its additive production, without finishing for subsequent production of a required surface structure being necessary. In particular, inner-lying surfaces of the component may advantageously be provided with particular surface properties by the described method.

This object is achieved by the subject matter of the independent patent claims. The dependent claims relate to advantageous configurations.

One aspect of the present invention relates to a method for providing a component to be produced layerwise or additively, advantageously from a powder bed, with a predetermined surface structure on a side surface of the component, advantageously a surface or a plane parallel to a construction direction of the component. The side surface furthermore advantageously represents an inner and/or outer surface of the component. The side surface may furthermore be an end side or end surface of the component.

In one configuration, the described method is an additive production method for the component.

The method comprises the selection of an irradiation pattern for solidifying a starting material in powder form for the component, in such a way that a surface irradiation vector and/or a contour irradiation vector of a component layer to be solidified are adjusted in a particular layer sequence in such a way that the predetermined surface structure is produced or formed during the layerwise construction.

The expression “contour” or “contour irradiation vector” advantageously applies to an edge or border of an individual material layer to be constructed during the production of the component.

In one configuration, the predetermined surface structure comprises a predetermined or defined surface roughness. The terms “surface roughness” and “surface structure” may be used synonymously in the present context.

In one configuration, the described method is a CAM method, or a method for computer-aided (additive) manufacturing.

One advantage of the method relates, in particular, to the possibility of providing optimized or tailored surfaces or surface structures in regions of the component which are inaccessible or difficult to access, for example on or in inner-lying flow or cooling channels. The predetermined surface structure advantageously makes it possible to reproducibly provide the component both internally and externally with defined surface properties that the individual use of the component requires.

In the case of inner-lying channels, for example, the surface structure may be selected during the additive method in such a way that either no turbulence is produced in the cooling flow or particular turbulences or swirl are imparted to the flow in order to achieve particular flow properties.

The term “surface irradiation vector”, or vector, relates in the present context to an irradiation or exposure trajectory or a corresponding path, according to which an energy beam, for example a laser beam, is guided over the powder bed in order to solidify a corresponding powder selectively and according to the desired geometry of the component. The energy beam may in this case be guided over the powder bed in a meandering fashion in order to remelt and solidify an area that is as large as possible. Individual irradiation paths—which may belong to the vector—are in this case advantageously separated from one another only slightly, so that a melt bath reaches the entire powder bed area to be melted.

The “adjustment” of the aforementioned vectors or irradiation paths (see below) may be carried out in a standard and computer-aided fashion by the guiding of corresponding irradiation or laser optics.

The expression “contour irradiation vector” correspondingly relates advantageously to an irradiation path which covers only the outer contours, for example as seen in a top view of the component. The purpose of such contour runs is to improve a possibly insufficient or defective irradiation or construction outcome after each constructed layer by corresponding contour exposure.

In one configuration, the contour irradiation vector of a component layer to be solidified is offset parallel to a layer plane relative to a previously constructed component layer, so that a layerwise offset only of contours of the component layer relative to the (previously) constructed component layer of at least 10 μm is produced.

In one configuration, the contour irradiation vector is selected in such a way that it forms a projection in the component, which defines the predetermined surface structure for the correspondingly exposed layer of the component.

In one configuration, the surface irradiation vector of a component layer to be solidified is offset parallel to a layer plane relative to a (not necessarily immediately) previously constructed component layer, or the previously selected surface irradiation vector, so that a layerwise or lateral offset of this component layer relative to the preceding, or previously constructed and solidified, component layer of at least 10 μm is produced or formed.

In one configuration, the layerwise offset is produced alternately, i.e. for example according to the given layer sequence or periodicity in a forward and back direction, only every 2, 3, 5, 10, 20, 50 or 100 layers, that is to say with a periodicity of 2, 3, 5, 10, 20, 50 or 100, during the construction of the component.

By means of the periodicity of the offsets introduced layerwise into the construction, and a corresponding offset length, the predetermined surface structure may advantageously be defined and reproducibly adjusted.

In one configuration, the predetermined surface structure is formed or provided on an (in the finished component) inner-lying surface of the component.

In one configuration, the finished component comprises at least one cavity, for example for guiding a cooling fluid during operation of the component. Accordingly, the cavity is advantageously defined at least partially by the aforementioned inner-lying surface.

The method furthermore comprises the provision of CAD data for the component, the irradiation pattern being selected and applied to the CAD data in the scope of a CAM method, by the surface irradiation vector and/or the contour irradiation vector being taken into account during a layer subdivision, the so-called “slicing”.

A further aspect of the present invention relates to a method for additive construction of the component, wherein the construction of the component is carried out on the basis of the selection of an irradiation pattern according to the described method. By the described additive production method, the component may be provided with the predetermined surface structure particularly expediently as a whole or only on particular regions according to the individual fields of use of the component.

In one configuration, the surface structure is a regular surface structure. According to this configuration, the surface structure or the surface roughness may, for example, be composed of regular unevennesses.

In one configuration, the surface structure is an irregular surface structure.

A further aspect of the present invention relates to a component which is produced or producible according to the described method, or which has been provided in the described way with the predetermined structure, and correspondingly comprises the latter.

A further aspect of the present invention relates to a computer program, to a computer program product and/or to a computer readable medium, respectively comprising commands or program instructions which, when the program is run by a data processing device such as a computer, cause the latter to carry out at least the step of selecting the irradiation pattern as described.

In one configuration, the computer program, computer program product and/or the computer readable medium is configured, for the selection of the irradiation pattern, to take a surface irradiation vector which is optimal for the respective application for the component in terms of its surface structure and/or a correspondingly optimal contour irradiation vector of a component layer to be solidified automatically from a (reference) database and, for example, to take it into account correspondingly in a CAM data set.

Configurations, features and/or advantages which relate here to the method or the computer program may furthermore apply to the component, or vice versa.

### BRIEF DESCRIPTION OF THE DRAWINGS

Further details of the invention will be described below with the figures.

FIG. 1 shows a schematic sectional view of a component to be produced additively with a surface structure according to the invention.

FIG. 2 shows a schematic sectional view of the component to be produced additively according to an alternative configuration.

FIG. 3 shows a schematic view of the component to be produced additively.

FIG. 4 shows a schematic view of the component to be produced additively according to an alternative configuration.

FIG. 5 shows a schematic flowchart which indicates method steps of the described method.

### DETAILED DESCRIPTION OF INVENTION

In the exemplary embodiments and figures, elements which are the same or have the same effect may respectively be provided with the same references. The elements represented and their size proportions with respect to one another are not in principle to be regarded as true to scale; rather, individual elements may be represented exaggeratedly thick or largely dimensioned for better representability and/or for better comprehensibility.

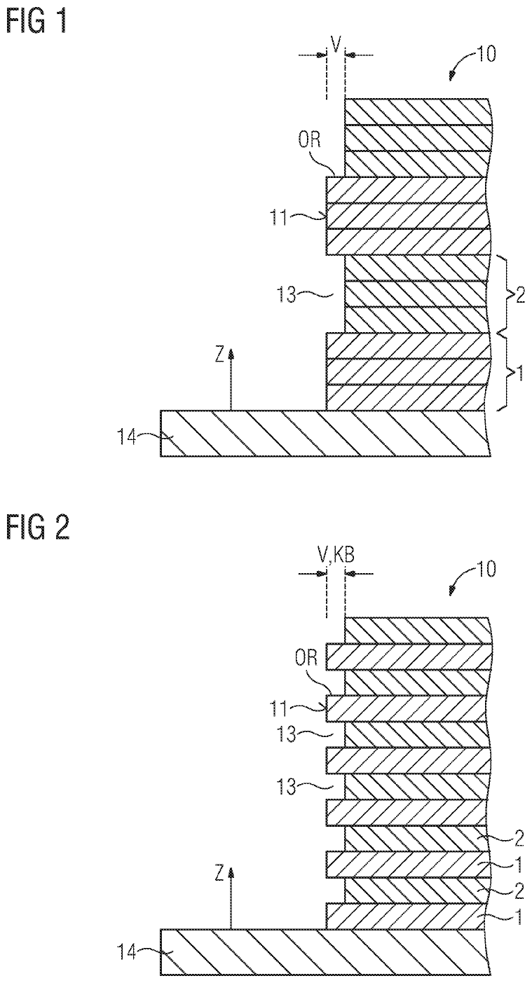

FIG. 1 shows a component 10. The component is advantageously shown during its additive production, i.e. at least parts of the component have been solidified layerwise by an additive production method, for example selective laser melting and/or electron beam melting. The component 10 is already constructed, or solidified, with twelve sheets or layers stacked along a construction direction Z. This is carried out in the described method advantageously selectively from a powder bed (not explicitly denoted) and with the aid of a laser or electron beam. In order to avoid stresses and/or deformations during the selective melting or sintering process which may occur because of the high temperature gradients involved, the component is advantageously constructed with a material fit on a construction platform 14.

It can be seen in FIG. 1 that the component 10 has been provided with an offset V with a periodicity of three layers, or layer thicknesses, by a suitable selection of the irradiation pattern. The first three layers (cf. reference 1 in FIG. 1) of the component 10 are constructed with a planar or flush side surface 11. In other words, an irradiation strategy has been selected in such a way that advantageously no offset V is produced within the first three layers. After the third layer 1, contour irradiation vectors KBV and/or surface irradiation vectors FBV, in particular of the fourth layer 1 of the component 10 in FIG. 1, have advantageously been selected in such a way that the fourth, fifth and sixth layers (cf. reference 2) have been offset to the right by an extent corresponding to the length V.

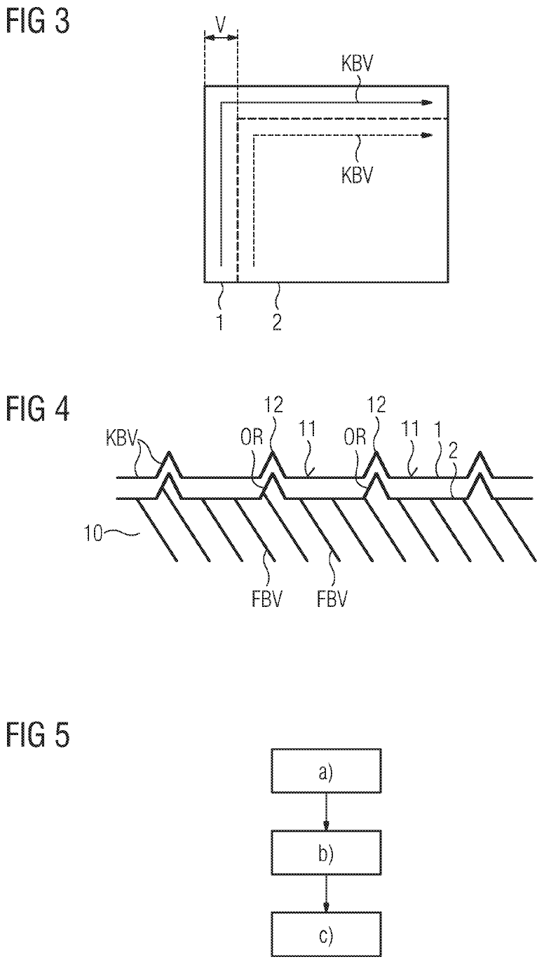

FIG. 3 illustrates the irradiation of a powder bed according to the contour irradiation vectors KBV (“contour runs”) of the energy beam. Such a “contour run” is usually carried out after surface-wide irradiation of the powder bed (cf. surface irradiation vector) in order to ensure the quality of the powder solidification at the edge of the component and/or in order to subsequently improve a solidification, at the edge of the component, which possibly is mechanically loaded more greatly than an inner region of the component.

After the additive construction of the fourth, fifth and sixth layers, the contour irradiation vector of the seventh layer to be constructed for the component 10 is correspondingly offset back to the left by the length V, so that an intermediate space 13 is formed. By the layerwise offsets produced in this way, a surface structure and/or surface roughness OR, which can be defined, adjusted or “tailored” by the periodicity and length of the offsets, is produced on the side surface 11 of the component. Layers nine to twelve of the component 10 are again offset to the right in a similar way to layers three to six.

The surface structure OR may furthermore be defined by the intermediate spaces 13. The surface structure may be a mean roughness, quadratic roughness, mean roughness depth or a mean roughness value.

The surface structure and/or the surface roughness OR may furthermore be regular or irregular.

FIG. 2 shows an alternative configuration of the component 10 relative to FIG. 1, or indicates a correspondingly adapted method according to the invention.

In contrast to FIG. 1, in which a periodicity of three was selected, the periodicity or layerwise frequency of the offsets is equal to 1. That is to say for each layer to be newly constructed, an offset V of the layer currently to be constructed in an alternating direction is defined relative to a previously irradiated or constructed layer by a corresponding selection of the irradiation pattern by means of the contour irradiation vectors.

Although only a periodicity of the layerwise offset of one and three is described in FIGS. 1 and 2, it is clear to the person skilled in the art that a periodicity of 2, 5, 10, 20, 50 or more layers may likewise be selected according to the invention and according to the surface structure intended to be achieved.

By the means of the present invention which are illustrated in FIGS. 1 and 2, the predetermined surface structure OR may advantageously in a controlled and reproducible fashion be produced, for example over the entire side surface 11 of the component 10, and adapted for the individual application fields, for example a flow optimization for cooling air in the case of turbine rotor blades.

According to FIGS. 1 and 2, the length V of the offset may be 10 μm, 20 μm advantageously 50 μm or 100 μm or more, for example 200 or 300 μm. The offset can likewise be selected differently according to a surface structure OR individually designed for the component 10.

In a similar way to FIGS. 1 and 2, FIG. 3 shows the contour irradiation of a layer 2 which is constructed on a layer 1 already irradiated and solidified previously.

The solidification of the material over the entire layer surface may in this case advantageously be carried out in a standard fashion.

However, contour irradiation is carried out for the (currently to be constructed) layer 2—in contrast to the layer 1 already solidified underneath—only further inward in order to generate the offset V.

The solid lines both for the edge of the component and for the contour irradiation vector KBV relate to the layer 1 (cf. FIGS. 1 and 2). On the other hand, the dashed lines, both for the edge of the component and for the contour irradiation vector KBV, relate to the layer 2.

Other than as suggested in the figures, the side surface 11 of the component may represent an inner lying surface thereof.

FIG. 4 indicates a further possibility of providing a controlled and predetermined surface structure, for example on a side surface 11 of the component 10. For illustration, a schematic view of the component 10 is shown. As an alternative or in addition to the offsets introduced by the contour irradiation vectors KBV, a surface irradiation vector FBV may also be varied layerwise in such a way that projections 12 are produced in the contour of the respectively constructed component layer and the predetermined surface structure OR is thus formed.

The projections 12 may be peaks. The position of the projections or peaks 12 may furthermore vary in each layer, in order to produce any desired roughnesses or surface geometries.

The surface irradiation vectors FBV are in the present case indicated (in the layer plane) as hatching of the powder layer correspondingly to be solidified currently.

In particular, FIG. 4 shows a situation in which, for example, a predetermined surface structure OR has been offset both by a corresponding offset of a contour irradiation vector KBV and by a layerwise offset of a surface irradiation vector of a powder layer currently to be constructed relative to a previously solidified layer.

These examples in the figures illustrate the wealth of degrees of latitude which exists by variation of the irradiation pattern during the additive production, in order to generate a defined surface structure for a correspondingly produced component 10.

FIG. 5 indicates a schematic flowchart comprising at least one method step according to the invention.

Method step a) advantageously denotes the provision of a CAD file for the component. This is prior art, since the provision of design data for the component is conventionally carried out by means of a CAD file read into a production system.

Method step b) advantageously describes the selection of the irradiation pattern as described with the aid of the preceding figures, namely in such a way that the component 10 is provided with the predetermined surface structure OR during the additive construction. In the scope of a CAM method, the irradiation pattern may be selected and applied to the existing CAD file, in such a way that, for the corresponding construction process in an additive production system, surface irradiation vectors and/or contour irradiation vectors are taken into account in a layer subdivision for the construction of the component.

Method step b) may be carried out partially or fully by a computer program.

Method step c) in the present case advantageously denotes the actual additive physical construction of the component 10 in such a way that a side surface of the component 10 is provided with the predetermined surface structure OR.

The description with the aid of the exemplary embodiments does not restrict the invention to these exemplary embodiments; rather, the invention comprises any new feature and any combination of features. This includes in particular any combination of features in the patent claims, even if this feature or this combination per se is not specifically indicated in the patent claims or exemplary embodiments.

1. A method for providing a component to be produced layerwise with a predetermined surface structure on a side surface of the component, the method comprising:
providing CAD data for the component, and
selecting an irradiation pattern for solidifying a starting material in powder form for the component, in such a way that a surface irradiation vector and/or a contour irradiation vector of a component layer to be solidified are adjusted in a particular layer sequence in such a way that the predetermined surface structure is produced during the layerwise construction, the irradiation pattern being selected in the scope of a CAM method and being applied to the CAD data by the surface irradiation vector and/or the contour irradiation vector being taken into account during a layer subdivision.

2. The method as claimed in claim 1,
wherein the contour irradiation vector of a component layer to be solidified is offset parallel to a layer plane relative to a previously constructed component layer, so that a layerwise offset only of contours of the component layer relative to the constructed component layer of at least 10 μm is produced.

3. The method as claimed in claim 1,
wherein the contour irradiation vector is selected in such a way that it forms a projection in the component, which defines the predetermined surface structure.

4. The method as claimed in claim 1,
wherein the surface irradiation vector of a component layer to be solidified is offset parallel to a layer plane relative to a previously constructed component layer, so that a layerwise offset of this component layer relative to the constructed component layer of at least 10 μm is produced.

5. The method as claimed in claim 2,
wherein the layerwise offset is produced alternately only every 2, 3, 5, 10, 20, 50 or 100 layers.

6. The method as claimed in claim 1,
wherein the predetermined surface structure is provided on an inner-lying surface of the component.

7. The method as claimed in claim 1,
wherein the predetermined surface structure comprises a predetermined or defined surface roughness.

8. A component which is produced according to the method as claimed in claim 1, comprising:
the predetermined surface structure on a side surface.

9. A computer program stored on a non-transitory computer readable media, comprising:
commands which, when the program is run by a data processing device, cause the latter to carry out at least the step of selecting the irradiation pattern as claimed in claim 1.

10. The computer program stored on a non-transitory computer readable media as claimed in claim 9,
which is configured, for the selection of the irradiation pattern, to take a surface irradiation vector which is optimal for the respective application for the component in terms of its surface structure and/or a correspondingly optimal contour irradiation vector of a component layer to be solidified automatically from a database and to take it into account correspondingly in a CAM data set.

11. The method as claimed in claim 2,
wherein the layerwise offset only of contours of the component layer relative to the constructed component layer of at least 50 μm is produced.

12. The method as claimed in claim 4,
wherein the layerwise offset only of contours of the component layer relative to the constructed component layer of at least 50 μm is produced.
